(19) United States
(12) Patent Application Publication
(10) Pub. No.: US 2008/0144090 A1
(43) Pub. Date: Jun. 19, 2008

(54) IMAGE FORMING APPARATUS AND METHOD OF CONTROLLING IMAGE FORMING APPARATUS

(75) Inventors: Hiroyuki Kimura, Kawasaki-shi (JP); Yoichi Takaragi, Yokohama-shi (JP); Shinichi Fukada, Kawasaki-shi (JP); Tatsuo Shinagawa, Yokohama-shi (JP); Mineko Sato, Yokohama-shi (JP); Tsutomu Murayama, Yokohama-shi (JP); Kunio Yoshihara, Hachioji-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/937,922

(22) Filed: Nov. 9, 2007

(30) Foreign Application Priority Data
Dec. 19, 2006 (JP) 2006-341403

(51) Int. Cl. G06K 1/00

(52) U.S. Cl. 358/1.15

(57) ABSTRACT

A system which includes an image forming apparatus configured to perform a process according to instruction information that describes processing of document information. The system comprising, an receiving unit configured to receive document information and instruction information that describes processing of the document information, a registration unit configured to register instruction information and confirmation data which is used to confirm whether the processing described by the instruction information is to be performed on document information in association with each other, and a determination unit configured to determine whether an image forming apparatus can perform a process for the document information received by the receiving unit according to the instruction information received by the receiving unit, based on the instruction information received by the receiving unit and the confirmation data which is registered in the registering unit.

### BACKGROUND OF THE INVENTION

1. Field of the Invention

The present invention relates to an image forming apparatus which processes a job according to job instruction information that instructs the image forming apparatus to perform various operations.

2. Description of the Related Art

There is a workflow system for executing a process on an image forming apparatus according to job instruction information set by a user. Such job instruction information may include various information regarding processes that are to be executed by an image forming apparatus, such as scan instruction, scan setting, print instruction, print setting, and document saving.

Moreover, a method for managing the security of the job instruction information uses a technique of appending an electronic signature to the instruction information and verifying the electronic signature before executing the job.

In a case where an image forming apparatus regularly performs a complex process, it takes time to set the various functions of the image forming apparatus for each process. Therefore, an execution of any one of the various functions operable by an image forming apparatus can be selected by simply pressing a button in a conventional method. To improve such a method, a process is discussed which utilizes job instruction information. The job instruction information is information that describes process which is necessary to execute a job, and the functions which are used to execute a job. An information processing apparatus, such as an image forming apparatus, analyzes the process described in the job instruction information and automatically executes the described process.

However, the above-described method which utilizes the job instruction information has a following problem. Any user can use the job instruction information, so that, for example, a user B can erroneously use the job instruction information which is created by a user A. The user B may then send important documents to a person who is not a customer of user B.

To solve the above-described problem, an access right can be set on an image forming apparatus to restrict users who can use the job instruction information. However, even when users are restricted, the created instruction information may not be appropriate for executing a job. In addition, description of the instruction information may be altered.

Japanese Patent Application Laid-Open No. 2004-288112 solves the above-described problem by appending an electronic signature to job instruction information and verifying the electronic signature before performing a process flow. As a result, the technique prevents altering of the instruction information or spoofing. In addition, since a third person approves the job instruction information, an error in the instruction information has a good chance of being found, as compared to when the instruction information is created by one person.

However, Japanese Patent Application Laid-Open No. 2004-288112 does not place any restriction on document information to be processed by the image forming apparatus. Therefore, inappropriate document information may be processed even in a case where the job instruction information is genuine and is approved by verifying the electronic signature. Such a problem is not considered in the above described techniques.

### SUMMARY OF THE INVENTION

According to an aspect of the present invention, A system which includes an image forming apparatus configured to perform a process according to instruction information that describes processing of document information. The system comprising, an receiving unit configured to receive document information and instruction information that describes processing of the document information, a registration unit configured to register instruction information and confirmation data which is used to confirm whether the processing described by the instruction information is to be performed on document information in association with each other, and a determination unit configured to determine whether an image forming apparatus can perform a process for the document information received by the receiving unit according to the instruction information received by the receiving unit, based on the instruction information received by the receiving unit and the confirmation data which is registered in the registering unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a cross-sectional view illustrating an example of a configuration of an image forming apparatus according to an exemplary embodiment of the present invention.

FIG. 2 is a block diagram illustrating components of the image forming apparatus according to the exemplary embodiment of the present invention.

FIG. 3 illustrates an example of an operation unit of the image forming apparatus according to the exemplary embodiment of the present invention.

FIG. 4 is a schematic view of a hard disk drive (HDD) of the image forming apparatus for storing image data and management data according to the exemplary embodiment of the present invention.

FIG. 5 illustrates a display screen for registering a scanned feature image according to the exemplary embodiment of the present invention.

FIG. 6 illustrates a display screen for confirming contents that are registered in an instruction according to the exemplary embodiment of the present invention.

FIG. 7 illustrates an example of a system which includes an instruction management server according to the exemplary embodiment of the present invention.

FIG. 8 is a flowchart illustrating a process for registering an instruction according to the exemplary embodiment of the present invention.

FIG. 9 is a flowchart illustrating a process for executing an instruction according to the exemplary embodiment of the present invention.

FIG. 10 illustrates a data structure of an instruction according to the exemplary embodiment of the present invention.

FIG. 11 is a table which indicates the relation between electronic signature and expiration date of an instruction illustrated in FIG. 10 according to the exemplary embodiment of the present invention.

FIG. 12A illustrates an example of a verification image described in the instruction, and FIG. 12B illustrates an example of a scanned image which is verified according to the exemplary embodiment of the present invention.

FIG. 13 illustrates a configuration of an instruction management server according to the exemplary embodiment of the present invention.

### DETAILED DESCRIPTION OF THE EMBODIMENTS

Various exemplary embodiments, features, and aspects of the invention will be described in detail below with reference to the drawings.

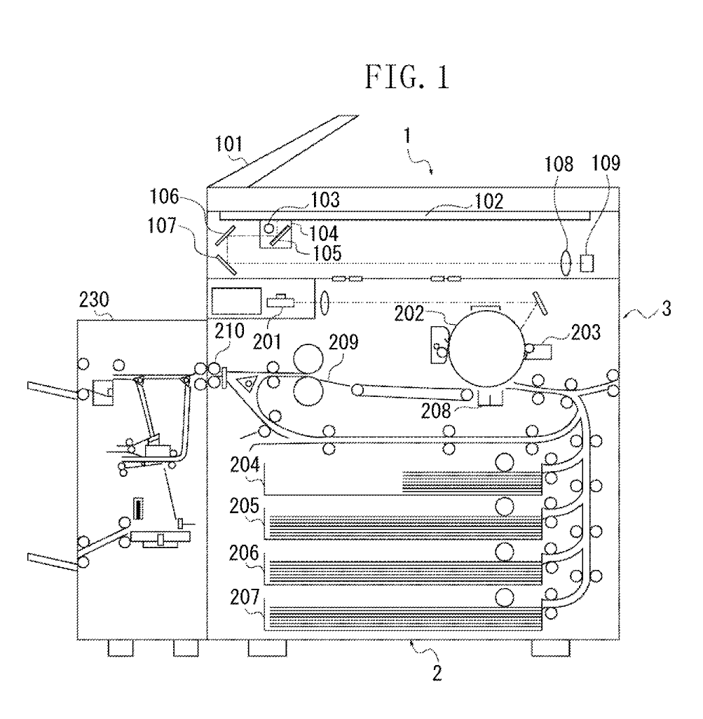

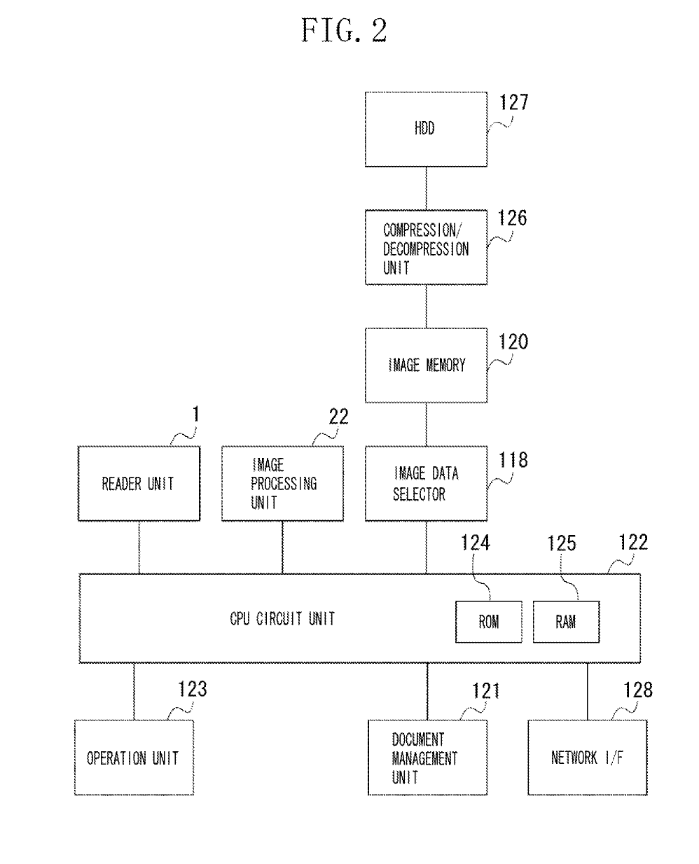

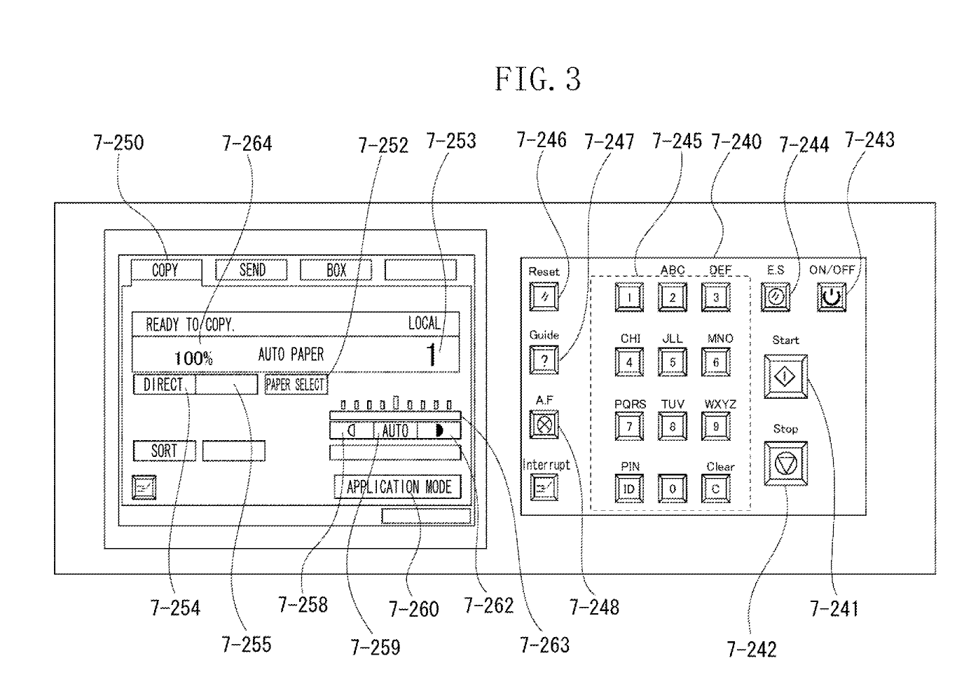

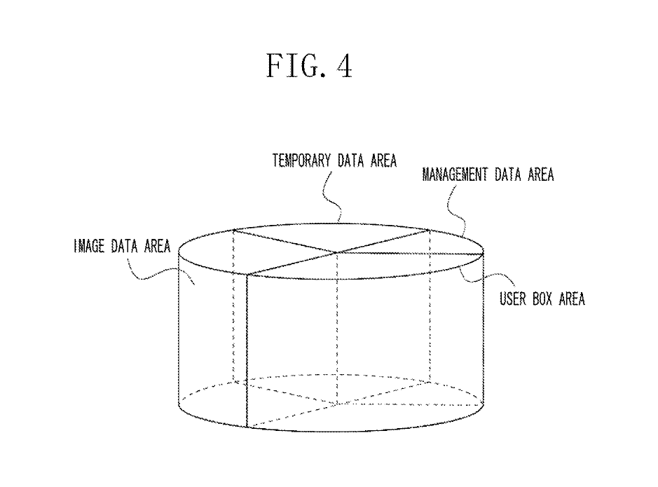

FIG. 1 is a cross-sectional view of a configuration of an image forming apparatus according to an exemplary embodiment of the present invention. FIG. 2 is a block diagram of components in the image forming apparatus. FIG. 3 illustrates an example of an operation unit of the image forming apparatus. FIG. 4 is a schematic view of a hard disk drive (HDD) of the image forming apparatus for storing image data and management data according to the exemplary embodiment of the present invention.

Referring to FIG. 1, an image forming apparatus (or an image processing apparatus) 3 includes a reader unit 1, a printer unit 2, and a book binding unit 230.

A document which is placed on a document feeder 101 of the read unit 1 is conveyed one after another to a document positioning glass plate 102. When the document is conveyed to a predetermined position on the document positioning glass plate 102, a lamp 103 in a scanner unit 104 is switched on, and the scanner unit 104 moves and irradiates the document. Reflected light from the document forms an image on a charge-coupled device (CCD) image sensor 109 via mirrors 105, 106, 107, and a lens 108, and the light is converted into an electrical signal. The electrical signal is then sent to an exposure control unit 201 in the printer unit 2.

The exposure control unit 201 includes a laser and a polygon scanner. The laser beam is modulated according to the above-described image signal which is converted into an electric signal by the CCD image sensor 109 and is subjected to a predetermined image processing. The exposure control unit 201 irradiates a photosensitive drum 202 with the modulated laser beam. As a result, a latent image is formed on the photosensitive drum 202, and developed by a development unit 203.

A transfer sheet is conveyed from a transfer sheet loading unit 204 or transfer sheet loading units 205, 206, and 207, in synchronization with the head of the developed image. A transfer unit 208 transfers the developed image onto the conveyed transfer sheet. A fixing unit 209 fixes the transferred image onto the transfer sheet, and an ejecting unit 210 ejects the transfer sheet to the outside of the image forming apparatus. The transfer sheet ejected from the ejecting unit 210 is conveyed to the book binding unit 230. If there is an instruction to bind a transfer sheet ejected from the ejecting unit 210, the book binding unit 230 performs a binding process. On the contrary, when there is no instruction to bind the transfer sheet, the book binding unit 230 ejects the transfer sheet without performing binding.

Control system of the image forming apparatus 3 will be described below by referring to FIG. 2.

In FIG. 2, the control system of the image forming apparatus 3 includes an image memory 120. An image data selector 118 sends image data to the image memory 120 according to an instruction from a central processing unit (CPU) circuit unit 122. The image memory 120 stores the image data in a specific area and reads out the image data from the specific area.

The CPU circuit unit 122 controls the reader unit 1, an image processing unit 22, an operation unit 123, a document management unit 121, the image data selector 118, the image memory 120, and a compression/decompression unit 126. The CPU circuit unit 122 further includes a read-only memory (ROM) 124, a random access memory (RAM) 125, and various timer control units (not illustrated). The ROM 124 stores a control program and an error correction program. The RAM 125 is used as a work area of the various programs. The CPU circuit unit 122 performs control to compress necessary data among the image data which is stored in the image memory 120, using the compression/decompression unit 126, and to store the compressed data in a hard disk (HDD) 127. On the other hand, the CPU circuit unit 122 performs control to load image data that is stored in the HDD 127 onto the image memory 120, via the compression/decompression unit 126.

The control system of the image forming apparatus 3 includes the document management unit 121. Electronic data of an image which is read by the reader unit 1 is stored in the HDD 127 via the image data selector 118, and attribute information of the image data is stored in the document management unit 121. Attribute information includes number of pages, document identification number (ID), file name, expiration date, and security level of each electronic document. After electronic documents are merged, the CPU circuit unit 122 reads the security information managed by the document management unit 121. The CPU circuit unit 122 then calculates the security level after the document merging and stores the new security information in the document management unit 121.

The operation unit 123 in the image forming apparatus 3 includes various key groups that instructs an image operation such as image editing performed by the image processing unit 22, or number of copies. An image processing unit 22 is a circuit which performs image processing such as creating a mirror image, which is instructed through the operation unit 123. Furthermore, the operation unit 123 includes a display unit which displays description of the operation. A network interface unit 128 is in communication with external terminals.

FIG. 3 illustrates an example of the operation unit 123 of the image forming apparatus 3. A hard key group 7-240 and a liquid crystal display (LCD) unit 7-250 which includes an LCD are arranged on the operation unit 123.

In the hard key group 7-240, a start key 7-241 is a key to start copying. A stop key 7-242 stops the operation being performed by the image forming apparatus 3. A power switch key 7-243 is a key for switching on and off the power of the image forming apparatus 3. A power saving key 7-244 shifts the image forming apparatus 3 into a predetermined power saving mode. A restore key 7-246 returns the setting mode to a default state. A key group 7-245 includes a numerical keypad from 0 to 9, for inputting the number of copies or the zoom ratio. The key group 7-245 also includes a clear key for clearing an input from the numerical keypad. When a user inputs a number of copies into the key group 7-245, the display area 7-253 of the LCD unit 7-250 displays the input number of copies. A guide key 7-247 is a key for displaying various guide screens, and a user mode key 7-248 is a key for making various settings on the image forming apparatus 3.

The LCD unit 7-250 is a touch panel, and a user can enter an input by pressing the key displaying portion. The LCD unit 7-250 displays the status of the apparatus, a number of copies, a zoom ratio, selected paper, and various operation screens. The LCD unit 7-250 also displays touch keys. A key 7-252 is a key for selecting a paper feed tray or auto paper. Keys 7-258 and 7-262 are keys for adjusting the density. The density to be adjusted is displayed on the display area 7-263. A key 7-259 is a key and a display area for switching on and off the auto density control function. Keys 7-254 and 7-255 are keys for setting direct copying and zooming respectively. The zoom ratio is also displayed on a display area 7-264 of the LCD unit 7-250. A key 7-260 is an application mode key. When a user presses the key 7-260, the screen jumps to a screen for setting various modes.

The HDD 127 of the image forming apparatus 3 will be described below by referring to FIG. 4. The HDD 127 stores image data and management data sent via the compression/decompression unit 126 according to an instruction from the CPU circuit unit 122. The HDD 127 is divided into four areas, i.e., a user BOX area, a management data area, an image data area, and a temporary data area.

A file system is applied to the user BOX area and the management data area, and the user BOX area and the management data area can be accessed in units of files. The user BOX area stores a file in which file names/user names for realizing the user BOX function are written for each BOX.

A file system dedicated to image format is applied to the image data area and the temporary data area, and only images can be input to and output from the image data area and the temporary data area. The temporary data area is temporarily used and is not guaranteed against power discontinuity. The temporary data area is used for a copy function. A number is allocated to a portion of the user BOX area illustrated in FIG. 4, so that data can be stored in each BOX number.

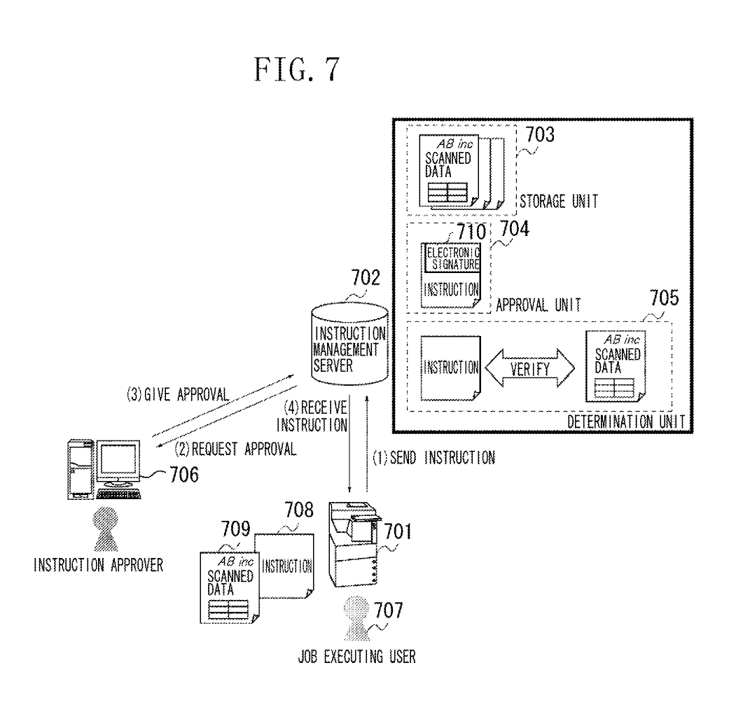

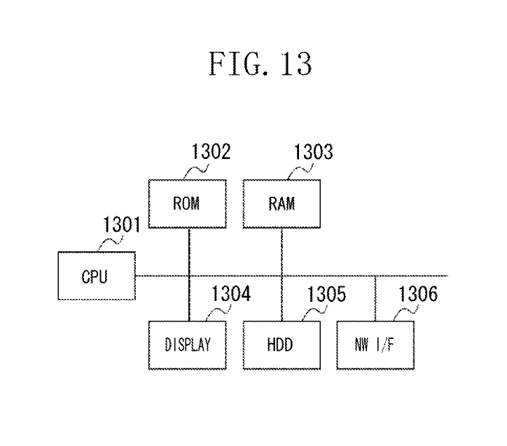

FIG. 7 illustrates an example of a system which includes an instruction management server 702 according to the exemplary embodiment of the present invention. FIG. 13 illustrates the configuration of the instruction management server 702. The instruction management server 702 includes a CPU 1301, a ROM 1302 which stores a program to be executed by the instruction management server 702, and a RAM 1303 which is used as a work area for executing a program. A display 1304 displays information, and a hard disk 1305 stores various instructions. A network interface 1306 is an interface for communicating with external terminals. A personal computer (PC) 706 of an instruction approver, illustrated in FIG. 7, has a similar configuration as the instruction management server 702. The CPU circuit unit 122 realizes the operation performed by the image forming apparatus 701 according to a program stored in the ROM 124. Furthermore, the CPU 1301 realizes the operation performed by the instruction management server 702 according to a program stored in the ROM 1302.

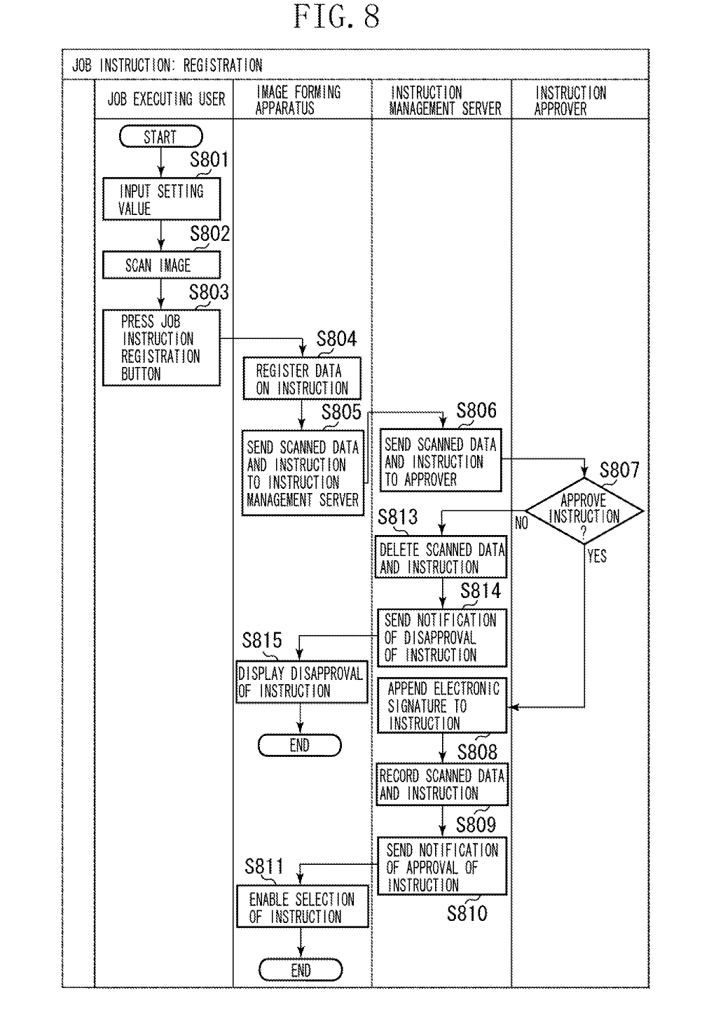

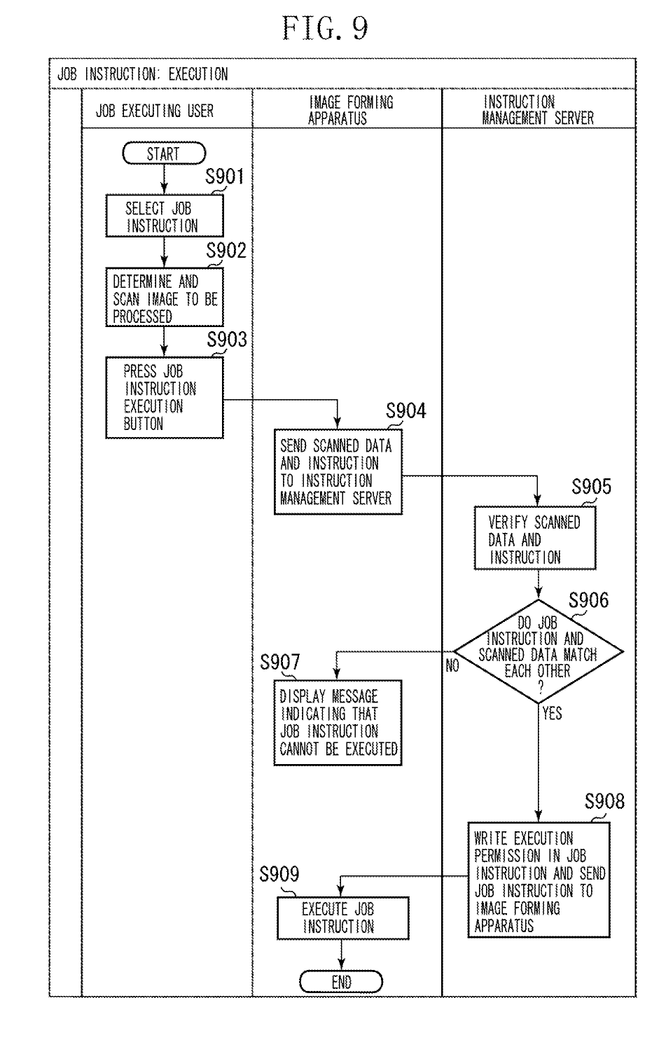

FIG. 8 illustrates a flowchart of a process for registering a job instruction according to the exemplary embodiment of the present invention. FIG. 9 illustrates a flowchart of a process for executing a job instruction according to the exemplary embodiment of the present invention. The registration and the execution of the job instruction will be described below. The CPU circuit unit 122 realizes operations performed by the image forming apparatus 701 according to a program stored in the ROM 124. Moreover, the CPU 1301 realizes operations performed by the instruction management server 702 according to a program stored in the ROM 1302. A CPU (not illustrated) in the PC 706 of the instruction approver realizes operations performed by the PC 706 according to a program stored in the PC 706.

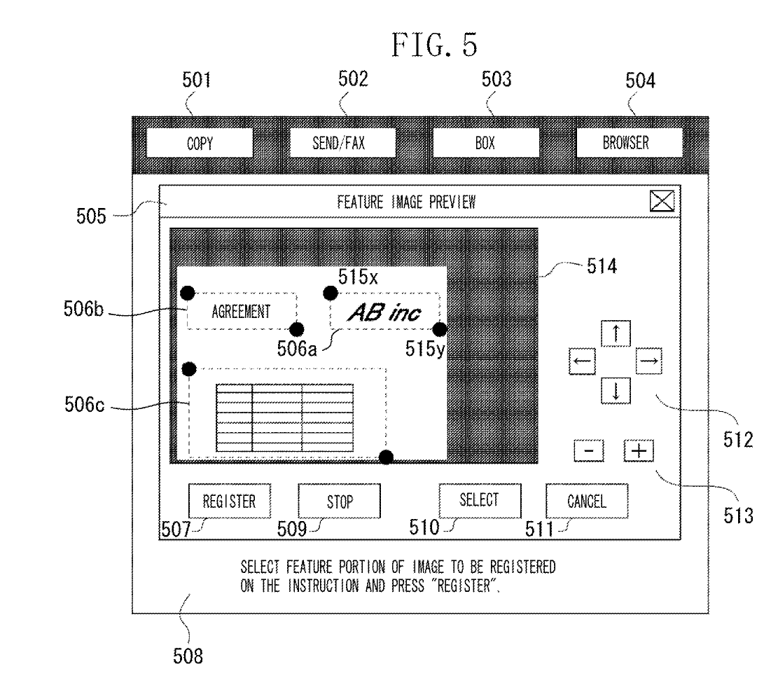

Referring to FIG. 8, a user 707 who executes a job sets a job instruction through an operation unit of the image forming apparatus 701 and inputs setting values (step S801). For example, the job executing user 707 sets a series of job flows as the job instruction (step S801) such as: “After making one copy on an A4-size paper, store a scanned image in the above-described second user BOX area of the HDD, and set the BOX name as ‘AB inc.’. When data storage in a BOX which is a BOX storage area is completed, send the scanned image to 03-xxxx-xxxx by facsimile.” The job executing user 707 then instructs the image forming apparatus 701 to scan a document 709 to be registered, with a scanner of the image forming apparatus 701 (step S802). The image forming apparatus 701 reads the document 709 according to the instruction and displays a preview sub-screen, as illustrated in FIG. 5, for registering a feature image of the scanned image.

FIG. 5 will be described below. FIG. 5 illustrates a display screen displayed by the LCD unit 7-250 of the operation unit 123 in the image forming apparatus 701. A button 501 is a button for displaying a basic copy screen. A button 502 is a button for displaying a basic facsimile screen. A button 503 is a button for displaying a BOX screen which is used to operate an image stored in the BOX in the HDD 127. A button 504 is a button for displaying a web browser screen on the image forming apparatus 701. An operation sub-screen 505 is used to specify or confirm the feature of the scanned image. A preview area 514 displays the scanned image. A button 513 is a button for enlarging and reducing the size of the preview image. A button 512 is a button for moving the scanned image right and left or up and down within the preview area 514. FIG. 5 illustrates a state where feature images, surrounded by dotted lines 506a, 506b, and 506c, are selected. The feature image is one example of confirmation data which is used to confirm whether the processing described by the instruction information is to be performed on the document data.

A method in which a user manually selects a feature image will be described below. An operation screen of the image forming apparatus 701 is a touch sensor. The user touches around a logo “AB inc.”, as indicated by dots 515x and 515y, within the preview area 514 of the operation screen. Consequently, a dotted line 506a which surrounds the “AB inc.” logo is displayed. The dotted line 506a indicates that the user has selected the logo “AB inc.” as a feature image of the present job instruction. Similarly, the user selects “agreement” (indicated by dotted line 506b) as a feature image. Additionally, the user selects a table (indicated by dotted line 506c) in the image. The selection of a table indicates that the image is of a default format, and only the lines in the table are recognized and the numbers inside each cell is not recognized. That is, the table is selected to check whether the lines are present at a predetermined position in the document. The user can make the selection by setting an area as indicated by dots 515x and 515y, and pressing a “select” button 510. The user presses a “cancel” button 511 to cancel the selection. For example, the dot 515x of the selected feature image is selected and the user presses the “cancel” button 511 to cancel the selection. In the exemplary embodiment illustrated in FIG. 5, three images are selected, and a “register” button 507 is pressed to register the three selected images as feature images in an instruction. A user presses the “register” button 507 and the image information is registered in an instruction. A user can stop the registration of the feature images in the instruction by pressing a “stop” button 509. A description 508 informs a user that the present screen is a sub-screen for registering the feature image in an instruction.

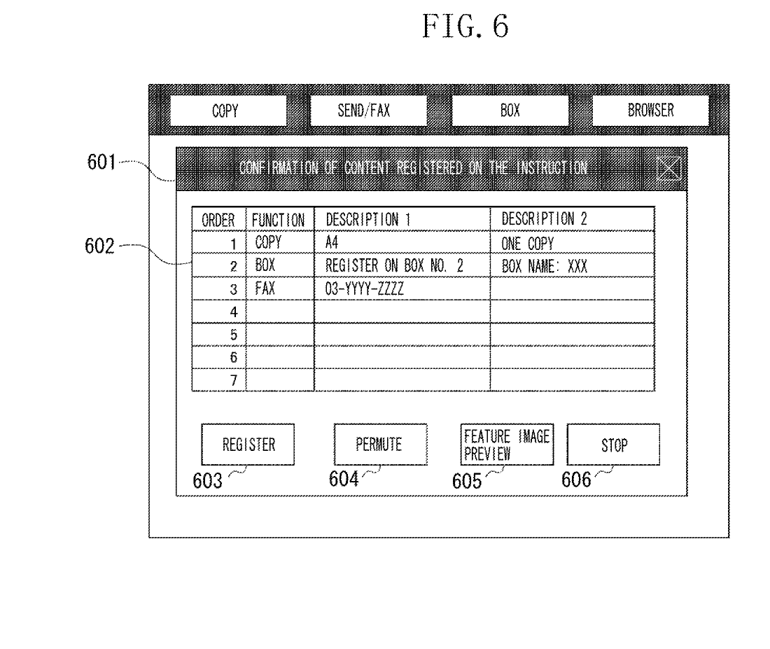

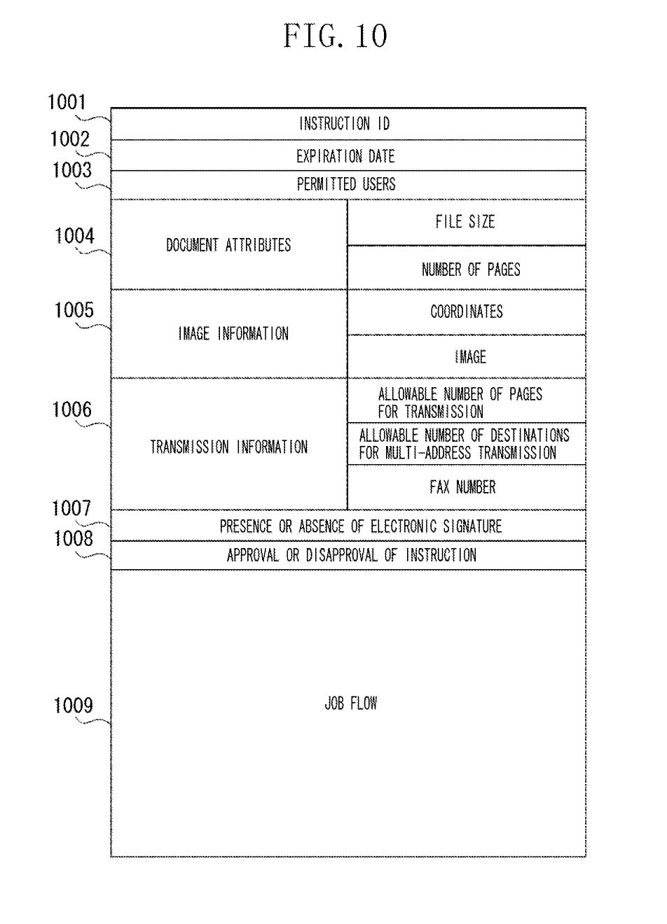

When a user presses the “register” button 507, the image forming apparatus 701 displays a sub-screen 601, as illustrated in FIG. 6, for confirming the contents that are registered in the instruction. A job instruction 602 displays the above-described job flow in the order of execution. “Permute” button 604 is a button for permuting (changing) the order of execution. For example, if a user wants to change the order of COPY and FAX, the user first touches “3” and presses the “permute” button 604. The user then touches “1”, and the order of COPY in 1 and FAX in 3 is changed. “Preview feature image” button 605 is a button for displaying the “feature image preview” screen illustrated in FIG. 5. “Stop” button 606 is a button for stopping the registration of an instruction. A “register” button 603 is a button for registering an instruction. When a user presses the “register” button 603 (step S803), the image forming apparatus 701 sets and stores each data of a job instruction, as illustrated in FIG. 10, onto the instruction 708 (step S804). At this time, the image forming apparatus 701 records the scanned image data and the coordinates of the scanned image data.

The image forming apparatus 701 sends the instruction 708 and the feature image to the instruction management server 702 (step S805). The instruction management server 702 sends the received instruction 708 and the feature image to the PC 706 of the instruction approver (step S806). The instruction approver determines whether to approve the received instruction 708 and the feature image (step S807). If the instruction approver does not approve the instruction 708 and the feature image (NO in step S807), the PC 706 of the instruction approver sends a notification disapproving the instruction, to the instruction management server 702. Upon receiving such a notification, the instruction management server 702 deletes the received job instruction 708 and the scanned data of the document 709 (step S813). The instruction management server 702 then sends a notification of disapproval of the instruction to the image forming apparatus 701 (step S814). The image forming apparatus 701 displays a disapproval of the instruction on the operation unit of the image forming apparatus 701 (step S815).

On the contrary, if the instruction approver determines that the received instruction 708 and the feature image are approved (YES in step S807), the PC 706 of the instruction approver sends a notification approving the instruction, to the instruction management server 702. Upon receiving such a notification, the approval unit 704 of the instruction management server 702 appends an electronic signature 710 to the instruction (step S808). The instruction management server 702 then records the feature image and instruction on the storage unit 703 of the instruction management server 702 in association with each other (step S809) After recording, the instruction management server 702 sends a notification of approval of the instruction to the image forming apparatus 701 (step S810). The image forming apparatus 701 enables only selection of the approved instruction in the image forming apparatus 701 (step S811).

The above exemplary embodiment describes a case where a user creates instruction information in the image forming apparatus 701 and registers the instruction information in the instruction management server 702. However, the present invention is not limited to the above embodiment. A user can create instruction information in a user PC (not illustrated) and register the instruction information and the document file that the user has created, on the instruction management server 702.

In the above exemplary embodiment, the instruction management server 702 is located outside the image forming apparatus 701. However, the functions of the instruction management server 702 can be included inside the image forming apparatus 701.

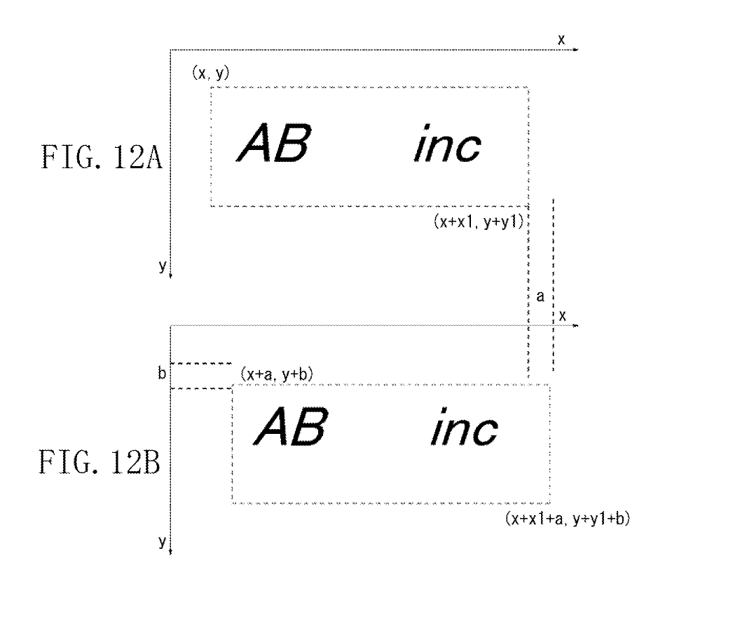

The flow of the process for executing a job instruction to which an electronic signature is appended will be described below by referring to FIG. 9. The job executing user 707 selects a job instruction on the operating unit of the image forming apparatus 701 (step S901). A user logging into the image forming apparatus 701 can be identified in a case where the system is configured to allow users to log into the image forming apparatus 701 using an electronic card. Therefore, a user logging into the image forming apparatus 701 can select only a job instruction which the user has access to. The user then determines the document 709 to be scanned by the scanner in the image forming apparatus 701 and scans the document 709 (step S902). The user presses an instruction execution button (not illustrated) which is displayed on the operation unit of the image forming apparatus 701 (step S903). The image forming apparatus 701 sends the instruction 708 and the scanned data of the document 709 to the instruction management server 702 (step S904). The instruction management server 702 receives the instruction 708 and the scanned data of the document 709. The instruction management server 702 verifies content of the instruction 708 and the scanned data of the document 709 (step S905) using a determination unit 705 in the instruction management server 702. The verification process will be described in detail below by referring to FIGS. 12A and 12B. The instruction management server 702 then determines whether the description in the instruction 708 and the scanned data of the document 709 match with each other (step S906). If the instruction 708 and the scanned data of the document 709 do not match with each other (NO in step S906), the instruction management server 702 sends a notification to the image forming apparatus 701 that the instruction cannot be executed. Upon receiving such a notification, the image forming apparatus 701 displays on the operating screen a message informing the user that the instruction cannot be executed (step S907). On the contrary, if the instruction 708 and the scanned data of the document 709 match with each other (YES in step S906), the instruction management server 702 writes a job execution permission in the instruction 708 and sends the instruction 708 to the image forming apparatus 701 (step S908). The image forming apparatus 701 then sequentially processes the scanned data of the document 709 according to the received instruction 708 (step S909).

In the above exemplary embodiment, a user sends the instruction information and document data (scanned data) from the image forming apparatus 701 to the instruction management server 702. However, the present invention is not limited to the above embodiment. A user can send the instruction information and document file which a user has created as a print job using the user PC (not shown), to the image forming apparatus 701. In such a case, the image forming apparatus 701 sends the instruction information to the instruction management server 702 to confirm whether processing in the instruction information can be executed, in a similar manner as in the above-described exemplary embodiment.

In the above exemplary embodiment, the instruction management server 702 is located outside the image forming apparatus 701. However, the functions of the instruction management server 702 can be included inside the image forming apparatus 701.

Data structure of a job instruction which is stored in the storage unit 703 of the instruction management server 702 will be described below by referring to FIG. 10.

As illustrated in FIG. 10, “Instruction ID” 1001 is an identification number (ID) for identifying an instruction, and which is allocated to all job instructions executed by the image forming apparatus 701. “Expiration date” 1002 is set when a document is created, to a predetermined period of time. In an item, “presence or absence of electronic signature” 1007, “present” is set if an electronic signature is appended to a job instruction.

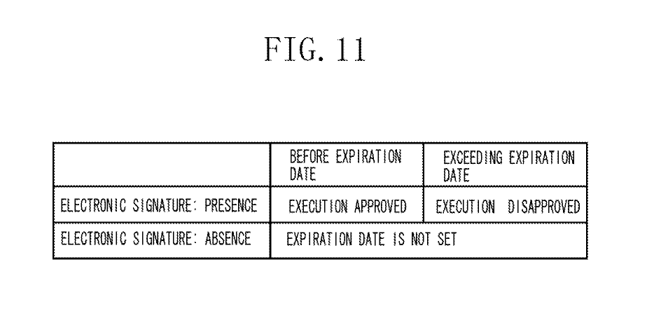

FIG. 11 is a table which illustrates a relation between “presence or absence of electronic signature” and “expiration date”. The table is used by the instruction management server 702 to determine whether to permit a job to be executed. When an electronic signature is “absent”, an expiration date can not be set, and therefore, the “expiration date” 1002 becomes blank. If “expiration date” 1002 is blank, when a job is to be executed, the job instruction is determined to be an unauthorized job instruction in which an expiration date is not set, and the job instruction is not executed. On the other hand, if an electronic signature is “present” but the present date exceeds the “expiration date” 1002, the job instruction cannot be executed. Therefore, “approval of instruction” can only be set in an item, “approval or disapproval of instruction” 1008, if an electronic signature is “present” and the present date does not exceed the expiration date.

An item, “permitted users” 1003, includes names of users who are permitted to use the instruction, and a plurality of users can be set. An item, “document attributes” 1004, stores the document attributes of the image data, and “file size” and “number of pages” are set at the time of registration.

An item, “image information” 1005, stores the image information attributes of the image data. For example, the position and the image of “AB inc.” logo which is registered as illustrated in FIG. 5 are stored in association with each other in the “image information” 1005. Although the position of a logo is fixed in a predetermined format such as a receipt, strictly speaking, there appears displacement in printing.

Therefore, when verifying the image data, the position of the logo is stored by adding some margin thereto. For example, when a feature image area is specified by an area indicated by (x, y) and (x+xl, y+yl), margins a and b are added as illustrated in FIG. 12B. Consequently, the user sets the width of the range of the feature image as (x±a, y±b) and (x+xl±a, y+yl±b) on an operating screen (not illustrated) of the image forming apparatus 701. As a result, the feature image is verified if the logo is located within the above-described range. In FIG. 12A, information recorded in an instruction are the storage location of the image data of the “AB inc.” logo in the HDD, and the area specified by (x, y) and (x+xl, y+yl). When the image data is verified, an image which is within the width of the previously set range and matches the “AB inc.” logo image illustrated in FIG. 12A is detected. FIG. 12B illustrates a scanned image to be executed, and since “AB inc.” logo exists within (x±a, y±b) and (x+x1±a, y+y1±b), the image can be detected and verified.

An item, “transmission information” 1006, indicates the category of the transmission information attribute. An item, “allowable number of pages for transmission”, indicates the number of pages that can be sent from the image forming apparatus 701. The number of pages is counted up while the pages can be sent until the number reaches the setting value. An item, “allowable number of destinations for multi-address transmission”, indicates the number of destinations to which transmission can be made simultaneously by multi-address transmission. “Allowable number of destinations for multi-address transmission” prevents personal information from being sent erroneously to tens of thousands of destinations. An item, “fax number”, registers the fax number of the destination, and the instruction restricts transmission to fax numbers other than the registered fax numbers. A job flow is registered in an item, “job flow” 1009, and jobs that can be performed by the image forming apparatus 701 are described in order. As described earlier, the table 602 illustrated in FIG. 6 is stored in the “job flow” 1009.

The above-described exemplary embodiment describes a method for determining whether job instruction information can be executed on a scanned image data. Similarly, it can also be determined whether job instruction information can be executed on an image data which is previously stored in an image forming apparatus.

### Other Exemplary Embodiments

The present invention can also be achieved by providing a storage medium, which stores software (program code) for realizing the operations of the above-described exemplary embodiments performed on various servers and image forming apparatus, to a system or an apparatus. The program code stored in the storage medium can be read and executed by a computer (central processing unit (CPU) or micro-processing unit (MPU)) of the system or the apparatus.

In this case, the software (program code) itself realizes the operations of the embodiments. The software (program code) itself and the storage medium, which stores the software (program code), constitute the present invention. The storage medium can be, for example, a floppy disk, a hard disk, an optical disk, a magneto-optical disk, a compact disc-read-only memory (CD-ROM), a CD-recordable (CD-R), a CD-rewritable (CD-RW), a digital versatile disc (DVD), a DVD-ROM, a magnetic tape, a nonvolatile memory card, or a ROM.

The above-described exemplary embodiments can be not only realized by executing program code read by a CPU. An operating system (OS) or the like working on a computer can also perform a part or the whole of processes according to instructions of the program code and realize functions of the above-described exemplary embodiments.

Furthermore, program code read from a storage medium can be stored in a memory equipped in a function expansion board inserted in a computer or a function expansion unit connected to a computer, and a CPU in the function expansion board or the function expansion unit can execute all or part of the processing based on the instructions of the program code to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-341403 filed Dec. 19, 2006, which is hereby incorporated by reference herein in its entirety.

What is claimed is:

1. A system which includes an image forming apparatus configured to perform a process according to instruction information that describes processing of document information, the system comprising:
an receiving unit configured to receive document information and instruction information that describes processing of the document information;
a registration unit configured to register instruction information and confirmation data which is used to confirm whether the processing described by the instruction information is to be performed on document information in association with each other; and
a determination unit configured to determine whether an image forming apparatus can perform a process for the document information received by the receiving unit according to the instruction information received by the receiving unit, based on the instruction information received by the receiving unit and the confirmation data which is registered in the registering unit.

2. The system according to claim 1, further comprising:
an extraction unit configured to extract a feature portion of an image,
wherein the registration unit registers the feature portion which is extracted by the extraction unit as the confirmation data.

3. The system according to claim 1, further comprising an instruction approval unit configured to approve the description of the instruction information.

4. The system according to claim 3, wherein:
the instruction information includes expiration date information; and
the instruction approval unit determines whether an image forming apparatus can execute a process based on the expiration date information.

5. The system according to claim 1, further comprising a reading unit configured to read confirmation data from the document information received by the receiving unit;
wherein the determination unit determine the image forming apparatus can perform a process according to the instruction information received by the receiving unit, when the reading unit read the confirmation data registered by the registration unit.

6. A method for performing a process according to instruction information that describes processing of document information, the method comprising:
receiving document information and instruction information that describes processing of the document information;
registering instruction information and confirmation data which is used to confirm whether the processing described by the instruction information is to be performed on document information in association with each other; and
determining whether an image forming apparatus can perform a process for the document information according to the received instruction information, based on the received instruction information and the registered confirmation data.

7. The method according to claim 6, further comprising:
extracting a feature portion of an image; and
registering the extracted feature portion as the confirmation data.

8. The method according to claim 6, further comprising approving description of the instruction information.

9. The method according to claim 8, wherein:
the instruction information includes expiration date information; and
the method further comprises determining whether an image forming apparatus can execute a process based on the expiration date information.

10. The method according to claim 6, further comprising reading confirmation data from the received document information;
wherein determining the image forming apparatus can perform a process according to the received instruction information, when reading the registered confirmation data.

11. A computer-readable recording medium which stores a computer program for executing the method according to claim 6.

12. An image forming apparatus which performs a process according to instruction information that describes processing of document information, comprising:
a first receiving unit configured to receive document information;
a first sending unit configured to send to a management apparatus instruction information and confirmation data which is used to confirm whether the processing described by the instruction information is to be performed on document information;
a second sending unit configured to send to the management apparatus the document information received by the first receiving unit and the instruction information that describes the processing of the document information; and
a second receiving unit configured to receive information which indicates whether an image forming apparatus can perform a process according to the instruction information sent by the second sending unit, from the management apparatus,
wherein the image forming apparatus executes a process according to the information received by the second receiving unit.

13. A management apparatus comprising:
an receiving unit configured to receive document information and instruction information that describes processing of the document information;
a registration unit configured to register instruction information and confirmation data which is used to confirm whether the processing described by the instruction information is to be performed on document information in association with each other; and
a determination unit configured to determine whether an image forming apparatus can perform a process for the document information received by the receiving unit according to the instruction information received by the receiving unit, based on the instruction information received by the receiving unit and the confirmation data which is registered in the registering unit.
